(19) United States
(12) Patent Application Publication
(10) Pub. No.: US 2016/0082949 A1
(43) Pub. Date: Mar. 24, 2016

(54) SYSTEM FOR IMPROVING EXHAUST GAS PURIFYING PERFORMANCE OF DIESEL HYBRID ELECTRIC VEHICLE

(71) Applicant: Hyundai Motor Company, Seoul (KR)

(72) Inventor: Hwa Yong JANG, Hwaseong-Si (KR)

(73) Assignee: Hyundai Motor Company, Seoul (KR)

(21) Appl. No.: 14/570,170

(22) Filed: Dec. 15, 2014

(30) Foreign Application Priority Data
Sep. 22, 2014 (KR) 10-2014-0125703

(51) Int. Cl. B60W 20/00; F02D 29/02; F01N 3/20

(52) U.S. Cl. CPC B60W 20/1082; F01N 3/208; F02D 29/02; F01N 2900/14; F01N 2610/02; F01N 2610/146; Y10S 903/905

(57) ABSTRACT

A system for improving exhaust gas purification performance of a diesel hybrid electric vehicle in which an SCR catalyst is equipped in an exhaust line to reduce nitrogen oxide within exhaust gas may include a hybrid control unit configured to request an engine control unit to turn off an engine to make the diesel hybrid electric vehicle enter a hybrid driving mode, and an engine control unit configured to determine whether urea is required to be injected into a front of the SCR catalyst when receiving a request of an engine off from the hybrid control unit.

### CROSS-REFERENCE TO RELATED APPLICATION

The present application claims priority to Korean Patent Application No. 10-2014-0125703 filed Sep. 22, 2014, the entire contents of which is incorporated herein for all purposes by this reference.

### BACKGROUND OF THE INVENTION

1. Field of the Invention

The present invention relates to a system for improving exhaust gas purifying performance of a diesel hybrid electric vehicle. More particularly, it relates to a system for improving exhaust gas purifying performance of a diesel hybrid electric vehicle capable of improving exhaust gas purifying performance by first performing the reduction in nitrogen oxide by injecting urea through an exhaust line.

2. Description of Related Art

Generally, a diesel engine has better thermal efficiency than that of a gasoline engine to reduce fuel consumption, uses cheaper fuel than that of the gasoline engine to make driving cost economical, and has a wider use range of fuel than that of the gasoline engine to have use flexibility of alternative fuel.

Therefore, an interest in a diesel hybrid electric vehicle in which a diesel engine instead of a gasoline engine is applied to a hybrid electric vehicle using both of an electric motor and an engine as a power source of a diesel hybrid electric vehicle has increased.

As the diesel hybrid electric vehicle uses a diesel engine and an electric motor as at least two different power sources, the diesel hybrid electric vehicle is equipped with a post-processing apparatus applied to a general diesel vehicle for coping with exhaust gas regulations, in which the post-processing apparatus serves to remove harmful materials such as NOₓ, CO, THC, and particular matters (PM), which are generated during a combustion process of the diesel engine.

As the post-processing apparatus, there are various forms, such as a diesel oxidation catalyst (DOC) which oxidizes and purifies THC and CO, a diesel particulate filter (DPF) which collects particular matters (PM), a selective catalytic reduction (SCR) catalyst which purifies NOₓ by a reduction with ammonia NH₃, a lean NOₓ trap (LNT) catalyst which removes the NOₓ from exhaust gas components generated when a lean-burn engine is operated.

The SCR catalyst has excellent selectivity for nitrogen oxide, uses ammonia NH₃ as a reducing agent for purifying NOₓ among the exhaust gases of the diesel engine, and acquires ammonia generated by decomposing urea injected into a front of the SCR catalyst.

The diesel hybrid electric vehicle in which the SCR catalyst is equipped in the exhaust line reduces the NOₓ within the exhaust gas by a selective catalyst reaction using the ammonia acquired by the SCR catalyst. In detail, the urea injected into an exhaust pipe is decomposed into the ammonia NH₃ and then reacts with the nitrogen oxide NOₓ to reduce the nitrogen oxide within the exhaust gas during the reduction into nitrogen N2 and water vapor (H20).

The LNT catalyst adsorbs or occludes NOₓ included in the exhaust gas under lean atmosphere in which rich oxygen is present in the mixed gas (fuel+air) and reduces and desorbs the adsorbed or occluded NOₓ into or from nitrogen under the rich atmosphere in which oxygen leans in the mixed gas.

The rich atmosphere is formed by additionally supplying the engine fuel to perform the reduction of the nitrogen oxygen at the time of the desorption of the NOₓ to generate the reducing agent such as hydrogen H2, carbon monoxide (CO), and hydrocarbon (HC), in which the reducing agent reacts with the NOₓ adsorbed in the LNT catalyst to reduce the NOₓ into nitrogen N2.

Meanwhile, FIG. 1 is a schematic diagram illustrating a technology of controlling a urea injection quantity of a typical diesel engine vehicle.

As illustrated in FIG. 1, in the typical diesel engine vehicle, a conversion rate of ammonia is predicted based on previously configured modeling by figuring out a nitrogen oxide value at the front of the SCR catalyst of the exhaust line at the time of engine running and figuring out an SCR catalyst temperature based on an exhaust gas temperature and operates a required urea dosing quantity depending on the predicted conversion rate to perform urea dosing to efficiently purify the nitrogen oxide within the exhaust gas. In this case, an operation precision of the urea dosing quantity required by figuring out and feeding back the ammonia adsorption quantity of the SCR catalyst is secured.

For efficient purification of the exhaust gas, a study for applying the technology for applying the urea injection quantity even to the diesel hybrid electric vehicle has progressed.

In the case of the typical diesel hybrid electric vehicle, the nitrogen oxide adsorbed into the SCR catalyst is separated and discharged as the nitrogen at the time of injecting the urea to the front of the SCR catalyst while the engine is running. Describing in more detail, when the adsorption quantity of the nitrogen oxide of the SCR catalyst reaches a reference value and thus the separation discharge of the nitrogen oxide is required, the nitrogen oxide is separated and discharged as the nitrogen by the selective catalyst reduction reaction using the ammonia by injecting the urea into the front of the SCR catalyst.

However, on the verge of timing when the adsorption quantity of the nitrogen oxide of the SCR catalyst reaches the reference value, the engine is in an off state when the diesel hybrid electric vehicle enters a hybrid driving mode, and thus the exhaust gas temperature is low (exhaust gas temperature is low even though ignition on is maintained) and the urea may not be injected, such that the exhaust gas purifying performance may be reduced and the exhaust gas regulations may hardly be satisfied.

A study for applying a technology of controlling an LNT catalyst for efficient purification of exhaust gas to the diesel hybrid electric vehicle has progressed.

In the case of the typical diesel hybrid electric vehicle, the nitrogen oxide adsorbed into the LNT catalyst is decomposed by the reduction reaction and is discharged as nitrogen, when a regeneration of the LNT catalyst is required while the engine is running, that is, when the nitrogen oxide adsorbed into the LNT catalyst is reduced into the nitrogen and desorbed. Describing in more detail, when the adsorption quantity of the nitrogen oxide of the LNT catalyst reaches the reference value and thus the decomposition and discharge of the nitrogen oxide are required, the nitrogen oxide adsorbed into the LNT catalyst is decomposed into the nitrogen and is discharged by using the reducing agent.

However, on the verge of timing the adsorption quantity of the nitrogen oxide adsorbed into the LNT catalyst reaches the reference value, when the diesel hybrid electric vehicle enters the hybrid driving mode, the engine is in an off state, and thus the exhaust gas temperature is low and the LNT catalyst may not be regenerated, such that the exhaust gas purifying performance may be reduced and the exhaust gas regulations may hardly be satisfied.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a system for improving exhaust gas purification performance of a diesel hybrid electric vehicle capable of improving exhaust gas purifying performance by first performing the reduction in nitrogen oxide by injecting urea into a front of an SCR catalyst prior to entering a hybrid driving mode.

Additionally, various aspects of the present invention are directed to providing a system for improving exhaust gas purification performance of a diesel hybrid electric vehicle capable of improving exhaust gas purification performance by first performing a regeneration of an LNT catalyst prior to entering a hybrid driving mode.

According to various aspects of the present invention, a system for improving exhaust gas purification performance of a diesel hybrid electric vehicle in which an SCR catalyst is equipped in an exhaust line to reduce nitrogen oxide within exhaust gas may include a hybrid control unit configured to request an engine control unit to turn off an engine to make the diesel hybrid electric vehicle enter a hybrid driving mode, and an engine control unit configured to determine whether urea is required to be injected into a front of the SCR catalyst when receiving a request of an engine off from the hybrid control unit.

When it is determined that the engine control unit is required to inject the urea into the front of the SCR catalyst, the engine control unit may control a urea injection into the front of the SCR catalyst without turning off a driving mode of the engine.

When it is determined that the urea injection into the front of the SCR catalyst is required when the engine control unit receives the request of the engine off from the hybrid control unit, the engine control unit may transmit a signal to the hybrid control unit to inform that the engine off is not performed.

When it is determined that the urea injection into the front of the SCR catalyst is completed when the engine control unit receives the request of the engine off from the hybrid control unit, the engine control unit may transmit a signal to the hybrid control unit to inform an ending of the urea injection.

When it is determined that the urea injection into the front of the SCR catalyst is not required when the engine controller receives the request of the engine off from the hybrid control unit, the engine controller may turn off the engine.

According to various aspects of the present invention, a system for improving exhaust gas purification performance of a diesel hybrid electric vehicle in which an LNT catalyst is equipped in an exhaust line to reduce nitrogen oxide within exhaust gas may include a hybrid control unit configured to request an engine control unit to turn off an engine to make the diesel hybrid electric vehicle enter a hybrid driving mode and an engine control unit configured to determine whether a regeneration of the LNT catalyst is required when receiving a request of an engine off from the hybrid control unit.

When it is determined that the engine control unit requires the regeneration of the LNT catalyst, the engine control unit may control fuel injection to regenerate the LNT catalyst without turning off a driving mode of the engine.

When it is determined that the regeneration of the LNT catalyst is required when the engine control unit receives a request of the engine off from the hybrid control unit, the engine control unit may transmit a signal to the hybrid control unit to inform that the engine off mode is not performed.

When it is determined that the regeneration of the LNT catalyst is completed when the engine control unit receives the request of the engine off mode from the hybrid control unit, the engine control unit may transmit a signal to the hybrid control unit to inform a regeneration ending of the LNT catalyst.

When it is determined that the regeneration of the LNT catalyst is not required when the engine controller receives the request of the engine off mode from the hybrid control unit, the engine controller may turn off the engine.

According to various aspects of the present invention, a system for improving exhaust gas purification performance of a diesel hybrid vehicle in which a post-processing apparatus is equipped in an exhaust line to reduce harmful materials within exhaust gas generated during a combustion process of a diesel engine may include a hybrid control unit configured to request an engine control unit to turn off an engine to make the diesel hybrid electric vehicle enter a hybrid driving mode, and an engine control unit configured to determine whether a regeneration of the post-processing apparatus is required when receiving a request of an engine off from the hybrid control unit.

According to the system for improving exhaust gas purification performance of a diesel hybrid electric vehicle in accordance with various embodiments of the present invention, it is possible to improve the exhaust gas purification performance by first performing the reduction in the nitrogen oxide prior to entering the hybrid driving mode, thereby satisfying the strict exhaust gas regulations of Europe.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram illustrating a technology of controlling a urea injection quantity of a typical diesel engine vehicle.

FIG. 2 is a flow chart schematically illustrating an exemplary method for improving exhaust gas purification performance of a diesel hybrid electric vehicle according to the present invention.

FIG. 3 is a diagram for describing a driving mode of a diesel hybrid electric vehicle.

FIG. 4 is a flow chart schematically illustrating an exemplary method for improving exhaust gas purification performance of a diesel hybrid electric vehicle according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention relates to a control technology of improving exhaust gas purification performance of a diesel hybrid electric vehicle in which an SCR catalyst is equipped in an exhaust line. The control technology of improving exhaust gas purification performance of a diesel hybrid electric vehicle may first perform the reduction in nitrogen oxide by injecting urea into a front of the SCR catalyst prior to entering a hybrid driving mode so as to separate and discharge nitrogen oxide adsorbed into an SCR catalyst as nitrogen and then enter the hybrid driving mode, thereby efficiently reducing the nitrogen oxide to secure the exhaust gas purification performance and satisfy exhaust gas regulations.

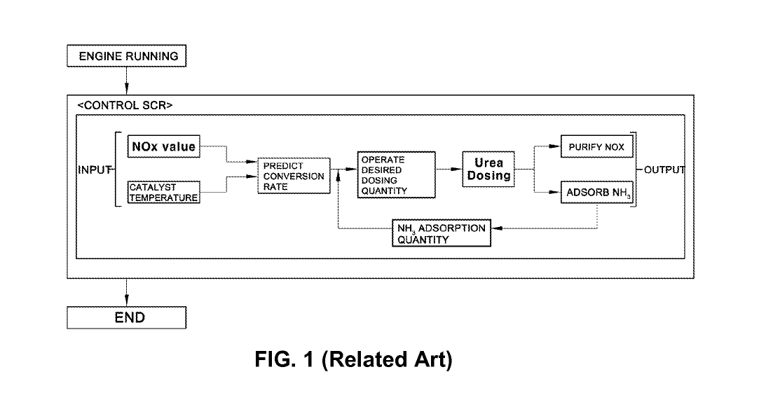

Referring first to FIG. 1, a diesel hybrid electric vehicle in which an SCR catalyst (post-processing apparatus) is equipped in an exhaust line predicts a conversion rate of ammonia based on modeling (using a previously configured table or map) by figuring out a nitrogen oxide value of the front of the SCR catalyst of the exhaust line at the time of controlling the SCR in an engine running mode and figuring out an SCR catalyst temperature based on an exhaust gas temperature and operates a required urea dosing quantity depending on the predicted conversion rate to perform urea dosing to efficiently purify the nitrogen oxide within the exhaust gas, thereby securing an operation precision of the urea dosing quantity required during the control of the SCR by figuring out and feeding back the ammonia adsorption quantity of the SCR catalyst.

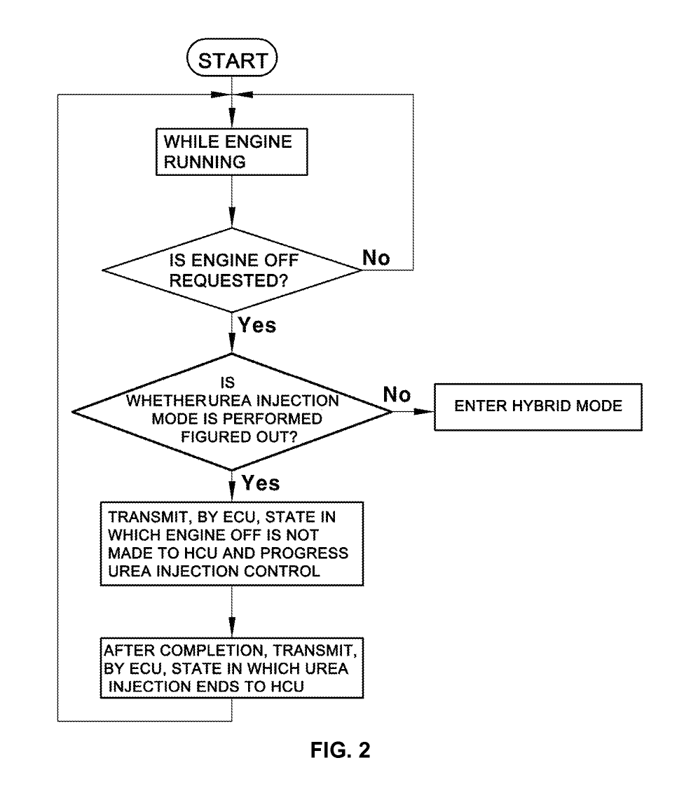

Referring to FIG. 2, for entering (that is, for driving the diesel hybrid electric vehicle as the hybrid driving mode) the hybrid driving mode of the diesel hybrid electric vehicle while the engine is running (or under the SCR control as described above), a hybrid control unit (HCU) transmits a signal requesting an engine control unit (ECU) to turn off a driving mode of an engine.

That is, when the hybrid control unit intends to convert a driving mode into the hybrid driving mode while the engine of the diesel hybrid electric vehicle is running, the hybrid control unit requests the engine control unit to stop a driving mode of the engine.

Describing in more detail, on the verge of timing when the urea is injected into the front of the SCR catalyst of the exhaust line while the engine is running, for example, immediately after a urea dosing quantity to be injected to the front of the SCR catalyst when the engine is running is operated or immediately before the urea is injected to the front of the SCR catalyst while the engine is running, for driving the diesel hybrid electric vehicle in the hybrid driving mode, the hybrid control unit requests the engine control unit to turn off the driving of the engine.

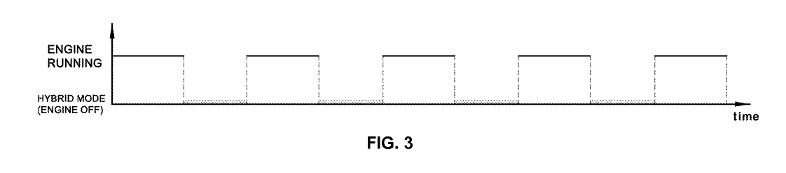

Referring to FIG. 3, the driving mode of the diesel hybrid electric vehicle may be largely classified into an engine running mode and a hybrid driving mode. In the case of the engine running mode, a diesel hybrid electric vehicle is driven using a diesel engine as a power source and in the case of the hybrid driving mode, the diesel engine is in an off stage and uses only an electric motor as the power source.

In the case of the diesel hybrid electric vehicle, the diesel hybrid electric vehicle enters the hybrid driving mode several times during the driving mode and the engine running (driving) stops when the diesel hybrid electric vehicle enters the hybrid driving mode while the engine is running. In this case, the diesel hybrid electric vehicle maintains an ignition on state for the engine running.

When the engine control unit receives an engine off signal from the hybrid control unit, the engine control unit first determines whether a urea injection mode is performed to determine whether the urea injection into the front of the SCR catalyst is required (that is, determines whether the regeneration of the SCR catalyst is required).

If it is determined that the engine control unit is not required to inject the urea into the front of the SCR catalyst (that is, if it is that the urea injection mode is not performed), the engine is turned off depending on a request of the hybrid control unit so that the diesel hybrid electric vehicle may enter the hybrid driving mode.

If it is determined that the engine control unit is required to inject the urea into the front of the SCR catalyst (that is, if it is determined that the urea injection mode is performed), the engine control unit transmits a signal informing the hybrid control unit of a state in which the engine may not be turned off.

In this case, the engine control unit performs the urea injection into the front of the SCR catalyst in the state in which the engine running is maintained and transmits a signal informing the hybrid control unit of the ending of the urea injection after the urea injection is completed.

The engine control unit is required to inject the urea into the front of the SCR catalyst when an adsorption quantity of the nitrogen oxide adsorbed into the SCR catalyst reaches a preset reference value.

The hybrid control unit receiving an ending signal of the urea injection recognizes the state in which the engine may be turned off.

The present invention is to satisfy exhaust gas regulations of the diesel hybrid electric vehicle in which the SCR catalyst is equipped in the exhaust line and when the diesel hybrid electric vehicle intends to enter the hybrid driving mode at the timing when the urea injection into the front of the SCR catalyst is required, the urea injection is first performed prior to the mode conversion, thereby securing the exhaust gas purification performance and satisfying the exhaust gas regulations.

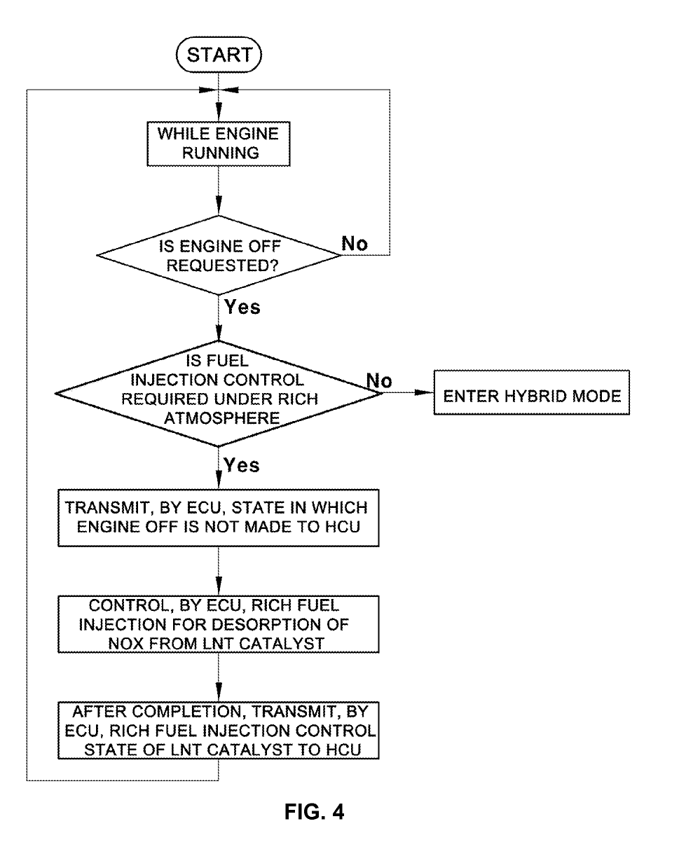

Meanwhile, various embodiments of the present invention will be described with reference to FIG. 4.

When the diesel hybrid electric vehicle intends to enter the hybrid driving mode during the engine running mode of the diesel hybrid electric vehicle in which an LNT catalyst (post-processing apparatus) is equipped in the exhaust line (that is, for driving the diesel hybrid electric vehicle in the hybrid driving mode), the hybrid control unit (HCU) of the diesel hybrid electric vehicle transmits the signal requesting the engine control unit (ECU) to request the driving off mode of the engine.

In other words, when the hybrid control unit intends to convert the driving mode into the hybrid driving mode while the engine is running of the diesel hybrid electric vehicle, the hybrid control unit requests the engine control unit to stop the driving mode of the engine.

As the LNT catalyst is accumulated with an adsorption quantity of nitrogen oxide during a lean control (controlling engine fuel injection under lean atmosphere) to adsorb the nitrogen oxide contained in the exhaust gas under the lean atmosphere in which oxygen is rich, an adsorption capacity (or adsorption rate) of the nitrogen oxide is reduced, and therefore when the adsorption quantity of the nitrogen oxide reaches a preset reference value, the lean control stops and the rich control (controlling the engine fuel injection under the rich atmosphere for the regeneration of the LNT catalyst) is performed.

Therefore, on the verge of timing when the adsorption quantity of the nitrogen oxide adsorbed into the LNT catalyst of the exhaust line while the engine is running reaches the preset reference value, the nitrogen oxide adsorbed into the LNT catalyst is desorbed by the rich control of the LNT catalyst.

Therefore, the engine control unit (ECU) rejects the engine off request of the hybrid control unit (HCU) and progresses the engine fuel injection (engine fuel injection under the rich atmosphere), due to when the process of desorbing the nitrogen oxide from the LNT catalyst is required, that is, on the verge of timing when the adsorption quantity of the nitrogen oxide adsorbed into the LNT catalyst reaches the reference value, and the like.

In other words, when the engine control unit (ECU) receives the engine off request from the hybrid control unit (HCU), it is first determined whether the engine fuel injection control (fuel injection control to additionally supply the engine fuel for supplying the reducing agent at the time of the regeneration of the LNT catalyst) to regenerate the LNT catalyst is required.

The rich atmosphere is formed by additionally performing the injection control on the engine fuel as compared with the case in which the nitrogen oxide is adsorbed under the lean atmosphere for the reduction reaction of the nitrogen oxide at the time of the rich control for desorbing the nitrogen oxide from the LNT catalyst and the reducing agents generated by additionally supplied fuel such as hydrogen (H2), carbon monoxide (CO), and hydrocarbon (HC) reduce the nitrogen oxide into nitrogen.

As the determination result, when the fuel injection control under the rich atmosphere for the regeneration of the LNT catalyst is unnecessary, the engine control unit (ECU) accepts the engine off request of the hybrid control unit (HCU) to enable the vehicle to enter the hybrid driving mode.

When the fuel injection control under the rich atmosphere for the regeneration of the LNT catalyst is required, the engine control unit (ECU) transmits the signal informing the hybrid control unit (HCU) of the state in which the engine off is not made and performs the fuel injection control for the desorption of the nitrogen oxide of the LNT catalyst (controlling the engine fuel injection additionally supplied for the supply of the reducing agent at the time of the regeneration of the LNT catalyst) to progress the regeneration of the LNT catalyst.

In this case, the engine control unit (ECU) progresses the regeneration of the LNT catalyst in the state in which the engine running is maintained and transmits the signal (that is, signal informing the ending of the fuel injection under the rich atmosphere) informing the hybrid control unit (HCU) of the ending of the regeneration of the LNT catalyst when the regeneration of the LNT catalyst is completed and then may perform the engine off control, and the like depending on the request of the hybrid control unit.

The present invention is to satisfy the exhaust gas regulations of the diesel hybrid electric vehicle in which the LNT catalyst is equipped in the exhaust line and when the diesel hybrid electric vehicle intends to enter the hybrid driving mode at the timing when the generation of the LNT catalyst is required, the regeneration control of the LNT catalyst is first performed prior to the mode conversion, thereby securing the exhaust gas purification performance and satisfying the exhaust gas regulations.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for improving exhaust gas purification performance of a diesel hybrid electric vehicle in which an SCR catalyst is equipped in an exhaust line to reduce nitrogen oxide within exhaust gas, comprising:
a hybrid control unit configured to request an engine control unit to turn off an engine to make the diesel hybrid electric vehicle enter a hybrid driving mode; and
an engine control unit configured to determine whether urea is required to be injected into a front of the SCR catalyst when receiving a request of an engine off from the hybrid control unit.

2. The system of claim 1, wherein when it is determined that the engine control unit is required to inject the urea into the front of the SCR catalyst, the engine control unit controls a urea injection into the front of the SCR catalyst without turning off a driving mode of the engine.

3. The system of claim 1, wherein when it is determined that the urea injection into the front of the SCR catalyst is required when the engine control unit receives the request of the engine off from the hybrid control unit, the engine control unit transmits a signal to the hybrid control unit to inform that the engine off is not performed.

4. The system of claim 1, wherein when it is determined that the urea injection into the front of the SCR catalyst is completed when the engine control unit receives the request of the engine off from the hybrid control unit, the engine control unit transmits a signal to the hybrid control unit to inform an ending of the urea injection.

5. The system of claim 1, wherein when it is determined that the urea injection into the front of the SCR catalyst is not required when the engine controller receives the request of the engine off from the hybrid control unit, the engine controller turns off the engine.

6. A system for improving exhaust gas purification performance of a diesel hybrid electric vehicle in which an LNT catalyst is equipped in an exhaust line to reduce nitrogen oxide within exhaust gas, comprising:
a hybrid control unit configured to request an engine control unit to turn off an engine to make the diesel hybrid electric vehicle enter a hybrid driving mode; and
an engine control unit configured to determine whether a regeneration of the LNT catalyst is required when receiving a request of an engine off from the hybrid control unit.

7. The system of claim 6, wherein when it is determined that the engine control unit requires the regeneration of the LNT catalyst, the engine control unit controls fuel injection to regenerate the LNT catalyst without turning off a driving mode of the engine.

8. The system of claim 6, wherein when it is determined that the regeneration of the LNT catalyst is required when the engine control unit receives a request of the engine off from the hybrid control unit, the engine control unit transmits a signal to the hybrid control unit to inform that the engine off mode is not performed.

9. The system of claim 6, wherein when it is determined that the regeneration of the LNT catalyst is completed when the engine control unit receives the request of the engine off mode from the hybrid control unit, the engine control unit transmits a signal to the hybrid control unit to inform a regeneration ending of the LNT catalyst.

10. The system of claim 6, wherein when it is determined that the regeneration of the LNT catalyst is not required when the engine controller receives the request of the engine off mode from the hybrid control unit, the engine controller turns off the engine.

11. A system for improving exhaust gas purification performance of a diesel hybrid vehicle in which a post-processing apparatus is equipped in an exhaust line to reduce harmful materials within exhaust gas generated during a combustion process of a diesel engine, comprising:
a hybrid control unit configured to request an engine control unit to turn off an engine to make the diesel hybrid electric vehicle enter a hybrid driving mode; and
an engine control unit configured to determine whether a regeneration of the post-processing apparatus is required when receiving a request of an engine off from the hybrid control unit.
